(19) United States
(12) Patent Application Publication
(10) Pub. No.: US 2024/0357691 A1
(43) Pub. Date: Oct. 24, 2024

(54) METHOD AND APPARATUS FOR TRANSCEIVING INFORMATION, AND COMMUNICATION SYSTEM

(71) Applicant: FUJITSU LIMITED, Kawasaki-shi Kanagawa (JP)

(72) Inventors: Guorong LI, Beijing (CN); Meiyi JIA, Beijing (CN); Xin WANG, Beijing (CN); Lei ZHANG, Beijing (CN)

(73) Assignee: FUJITSU LIMITED, Kawasaki-shi Kanagawa (JP)

(21) Appl. No.: 18/762,740

(22) Filed: Jul. 3, 2024

Related U.S. Application Data
(63) Continuation of application No. PCT/CN2022/070786, filed on Jan. 7, 2022.

(51) Int. Cl. H04W 76/20; H04W 24/10; H04W 92/18

(52) U.S. Cl. CPC H04W 76/20; H04W 24/10; H04W 92/18

(57) ABSTRACT

An apparatus for transceiving information, applicable to a second terminal equipment, includes: a receiver configured to: receive a radio resource control reconfiguration complete message form a first terminal equipment when the second terminal equipment is in a radio resource control idle mode or a radio resource control inactive mode, and cause the second terminal equipment to enter a radio resource control connected mode; and receive a radio resource control reconfiguration message from a network device; and processor circuitry configured to perform relay-related configuration of a PC5 interface and a Uu interface according to the radio resource control reconfiguration message.

### CROSS-REFERENCE TO RELATED APPLICATION

This application is a continuation application of International Application PCT/CN2022/070786 filed on Jan. 7, 2022, and designated the U.S., the entire contents of which are incorporated herein by reference.

### TECHNICAL FIELD

The embodiments of the present disclosure relate to the field of communication technologies.

### BACKGROUND

Sidelink relay (SL Relay) technique is studied in 5G Release 17 (R17), and it includes a scenario of terminal equipment (such as a UE) to a network device relay (UE-to-Network Relay). A New Radio (NR) Uu link is used on a Uu interface of a relay terminal equipment (a relay UE), and on a PC5 interface between a remote terminal equipment (a remote UE) and the relay UE, it is assumed to use a NR sidelink. In a scenario of the UE-to-Network Relay, the relay UE is also called a UE-to-Network relay UE.

FIG. 1 is a schematic diagram of a scenario of UE-to-Network Relay.

As shown by Scenario 1 in FIG. 1, a remote UE 101 is out of coverage (OOC) of a network device 100, and a relay UE 102 is in coverage (IC) of the network device 100.

As shown by Scenario 2 in FIG. 1, the remote UE 101 is in coverage (IC) of the network device 100, and the relay UE 102 is in coverage (IC) of the network device 100.

As shown by Scenario 3 in FIG. 1, the remote UE 101 is in coverage (IC) of a network device 100a, the relay UE 102 is in coverage (IC) of the network device 100, and the network device 100a is different from the network device 100.

In a protocol stack of Release 17 Layer 2 Sidelink relay (R17 L2 SL relay), the Sidelink Relay Adaptation Protocol (SRAP) is introduced. For the UE-to-Network relay, at both the PC5 interface and the Uu interface, for a control plane protocol stack and a user plane protocol stack, an SRAP sublayer is above a Radio Link Control (RLC) sublayer. Uu Service Data Adaptation Protocol (SDAP), Packet Data Convergence Protocol (PDCP) and Radio Resource Control (RRC) terminate between a remote UE and a network device (e.g., gNB), while SRAP, RLC, Media Access Control (MAC) and physical (PHY) layers terminate at each link (i.e., a link between the remote UE and the relay UE, and a link between the relay UE and the gNB).

FIG. 2 is a schematic diagram of a control plane protocol stack of UE-to-Network relay.

For UE-to-Network relay, an SRAP sublayer on the PC5 interface is only used for the bearer mapping purpose. For relaying of a message of the remote UE on a Broadcast Control Channel (BCCH) and a Paging Control Channel (PCCH), the SRAP sublayer does not appear at a PC5 hop. For a message of the remote UE on signaling radio bearer 0 (SRB0), the SRAP sublayer does not appear at a PC5 hop, but appears at a Uu hop for a downlink (DL) and an uplink (UL).

It should be noted that the above introduction to the technical background is just to facilitate a clear and complete description of the technical solutions of the present disclosure, and is elaborated to facilitate the understanding of persons skilled in the art. It cannot be considered that the above technical solutions are known by persons skilled in the art just because these solutions are elaborated in the Background of the present disclosure.

### SUMMARY

A terminal equipment (such as a UE) may communicate directly with a network device (such as Network or gNB), this communication path may be called a direct path. The terminal equipment may also communicate with the network device via a relay UE, this communication path may be called an indirect path. For service continuity of L2 UE-to-Network relay, in a case where the UE switches from the direct path to the indirect path (that is, direct to indirect path switch), the flow shown in FIG. 3 may be used.

As shown in FIG. 3, a process for the UE to switch from the direct path to the indirect path includes the following steps:

Step 0. Uplink data and/or downlink data (UL/DL data) are transmitted between a remote UE and a network device (e.g., gNB) via a Uu interface.

Step 1. The remote UE reports one or more candidate relay UEs and traditional Uu measurement results after measuring and/or discovering candidate relay UE(s).

The remote UE may at least report a relay UE ID, a serving cell ID of the relay UE, and SL measurement information, wherein the SL measurement information may be sidelink reference signal received power (sidelink-referencesignalreceivedpower, SL-RSRP) of a candidate relay UE, and if the SL-RSRP is not available, sidelink discovery reference signal received power (sidelink discovery-referencesignalreceivedpower, SD-RSRP) is used.

Step 2a. The gNB decides to switch the remote UE to a target relay UE.

Step 2b. The gNB transmits a radio resource control reconfiguration (RRCReconfiguration) message to the target relay UE, the message may at least include a local identifier (local/temp ID) of the remote UE, a layer 2 identifier (L2 ID) thereof, RLC configuration and bearer mapping configuration of the Uu interface and the PC5 interface for relaying.

Step 3. The gNB transmits the RRCReconfiguration message to the remote UE. Content of the message may at least include a Relay UE ID, PC5 RLC configuration and a related end-to-end radio bearer of a relay service. After receiving the RRCReconfiguration message of the gNB, the remote UE stops transmission of a user plane (UP) and a control plane (CP).

Step 4. The remote UE establishes a PC5 connection with the target relay UE.

Step 5. The remote UE transmits to the gNB a radio resource control reconfiguration complete (RRCReconfigurationComplete) message via the relay UE, to complete a path switch procedure.

Step 6. Between the remote UE and the gNB, a data path is switched from the direct path to the indirect path.

In the path switch procedure shown in FIG. 3, the relay UE may be in a radio resource control idle (RRC_idle) mode or a radio resource control inactive (RRC_inactive) mode or a radio resource control connected (RRC_connected) mode.

For handling the case where the relay UE may be in a radio resource control idle (RRC_idle) mode or a radio resource control inactive (RRC_inactive) mode, there may be the following options:

Option 1, the target relay UE for direct-to-indirect path switch is in the RRC_connected mode.

Option 2, a relay UE in the RRC_idle or RRC_inactive mode may be indicated as the target relay, and this case is supported by a scheme initiated by the remote UE, i.e., after receiving a path switch command (such as RRCReconfiguration), the remote UE establishes a PC5 link with the relay UE, and transmits a switch complete (such as RRCReconfigurationComplete) message via the relay UE, the switch complete message triggering the relay UE to enter the RRC_connected mode.

The inventor of the present disclosure finds that the above Option 1 and Option 2 each have some problems that need to be solved. For example, for Option 1, how to ensure that the target relay UE is in a connected mode is a problem to be solved; for Option 2, if the target relay UE is in the RRC idle or RRC_inactive mode, in step 2b of FIG. 3, the RRC reconfiguration message is not able to be transmitted to the relay UE, thus the direct-to-indirect path switch procedure shown in FIG. 3 may not be performed smoothly.

For at least one of the above problems, the embodiments of the present disclosure provide a method for transceiving information and an apparatus for the same, and a communication system, in which the network device transmits to the remote UE a radio resource control reconfiguration (RRC reconfiguration) message. The radio resource control reconfiguration (RRC reconfiguration) message includes information on the target relay UE in radio resource control connected (RRC connected) mode, thereby enabling the target relay UE to be in the RRC connected mode, which is conducive to switching a communication path between the remote UE and the network device by using the existing direct-to-indirect path switch flow, resulting in less service interruption time of the remote UE. In addition, its implementation mode is simple and the implementation complexity is low.

According to one aspect of the embodiments of the present disclosure, an apparatus for transceiving information is provided, applicable to a network device, the apparatus including a first transceiving unit, the first transceiving unit being configured to:
receive information on a candidate second terminal equipment (relay UE) transmitted by a first terminal equipment;
transmit a radio resource control reconfiguration message to the first terminal equipment, the radio resource control reconfiguration (RRC reconfiguration) message including information on a target second terminal equipment (relay UE) in a radio resource control connected (RRC_connected) mode; and
communicate with the first terminal equipment via the target second terminal equipment.

According to another aspect of the embodiments of the present disclosure, an apparatus for transceiving information is provided, applicable to a first terminal equipment (a remote UE), the apparatus including a second transceiving unit, the second transceiving unit being configured to:
transmit information on a candidate second terminal equipment (relay UE) to a network device;
receive a radio resource control reconfiguration (RRC reconfiguration) message transmitted by the network device, the radio resource control reconfiguration (RRC reconfiguration) message including information on a target second terminal equipment (relay UE) in a radio resource control connected (RRC_connected) mode; and
communicate with the network device via the target second terminal equipment.

One of advantageous effects of the embodiments of the present disclosure lies in: through transmitting, by the network device, a radio resource control reconfiguration message to the remote UE, and the radio resource control reconfiguration message including information on the target relay UE in radio resource control connected mode, it is possible to enable the target relay UE to be in the RRC connected mode, and is conducive to switching a communication path between the remote UE and the network device by using the existing direct-to-indirect path switch flow, resulting in less service interruption time of the remote UE; in addition, its implementation mode is simple and the implementation complexity is low.

Referring to the later description and drawings, specific implementations of the present disclosure are disclosed in detail, indicating a manner that the principle of the present disclosure can be adopted. It should be understood that the implementations of the present disclosure are not limited in terms of the scope. Within the scope of the spirit and terms of the appended claims, the implementations of the present disclosure include many changes, modifications and equivalents.

Features that are described and/or shown with respect to one implementation can be used in the same way or in a similar way in one or more other implementations, can be combined with or replace features in the other implementations.

It should be emphasized that the term “comprise/include” when being used herein refers to the presence of a feature, a whole piece, a step or a component, but does not exclude the presence or addition of one or more other features, whole pieces, steps or components.

### BRIEF DESCRIPTION OF DRAWINGS

An element and a feature described in a drawing or an implementation of the present embodiments of the present disclosure can be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of a scenario of UE-to-Network Relay;

FIG. 2 is a schematic diagram of a control plane protocol stack of UE-to-Network relay;

FIG. 3 is a schematic diagram of a process for a UE to switch from a direct path to an indirect path;

FIG. 4 is a schematic diagram of a method for transceiving information in the embodiments of a first aspect;

FIG. 5 is a schematic diagram of a method for transceiving information in the embodiments of a second aspect;

FIG. 6 is a schematic diagram of direct-to-indirect path switch in the case where a relay UE is in an RRC_idle or RRC_inactive mode;

FIG. 7 is a schematic diagram of an apparatus for transceiving information in the embodiments of a third aspect;

FIG. 8 is a schematic diagram of an apparatus for transceiving information in the embodiments of a fourth aspect;

FIG. 9 is a schematic diagram of an apparatus for transceiving information in the embodiments of a fifth aspect;

FIG. 10 is a schematic diagram of an apparatus for transceiving information in the embodiments of a sixth aspect;

FIG. 11 is a schematic diagram of an apparatus for transceiving information in the embodiments of a seventh aspect;

FIG. 12 is a schematic diagram of a terminal equipment in a communication system in the embodiments of an eighth aspect; and

FIG. 13 is a schematic diagram of a network device in a communication system in the embodiments of an eighth aspect.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which can adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as New Radio (NR), Long Term Evolution (LTE), LTE-Advanced (LTE-A), Wideband Code Division Multiple Access (WCDMA), High-Speed Packet Access (HSPA) and so on.

And, communication between devices in a communication system can be carried out according to a communication protocol at any stage, for example may include but be not limited to the following communication protocols: 1G (generation), 2G, 2.5G, 2.75G, 3G, 4G, 4.5G, 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: an Integrated Access and Backhaul node (IAB-node), a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: node B (NodeB or NB), evolution node B (eNodeB or eNB) and a 5G base station (gNB), etc., and may further includes Remote Radio Head (RRH), Remote Radio Unit (RRU), a relay or a low power node (such as femeto, pico, etc.). And the term “BS” may include some or all functions, each BS may provide communication coverage to a specific geographic region. The term “a cell” may refer to a BS and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services through a network device. The terminal equipment can be fixed or mobile, and can also be referred to as Mobile Station (MS), a terminal, Subscriber Station (SS), Access Terminal (AT) and a station and so on.

The terminal equipment may include but be not limited to the following devices: a Cellular Phone, a Personal Digital Assistant (PDA), a wireless modem, a wireless communication device, a wireless routing device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal, a relay terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipment as described above.

Without causing confusion, the terms “uplink control signal” and “Uplink Control Information (UCI)” or “Physical Uplink Control Channel (PUCCH)” are interchangeable, and the terms “uplink data signal” and “uplink data information” or “Physical Uplink Shared Channel (PUSCH)” are interchangeable.

The terms “downlink control signal” and “Downlink Control Information (DCI)” or “Physical Downlink Control Channel (PDCCH)” are interchangeable, and the terms “downlink data signal” and “downlink data information” or “Physical Downlink Shared Channel (PDSCH)” are interchangeable.

Moreover, transmitting or receiving a PUSCH can be understood as transmitting or receiving uplink data carried by the PUSCH, transmitting or receiving a PUCCH can be understood as transmitting or receiving uplink information carried by the PUCCH, transmitting or receiving a PRACH can be understood as transmitting or receiving a preamble carried by the PRACH; an uplink signal may include an uplink data signal and/or an uplink control signal, etc., or may also be referred to as UL transmission or uplink information or uplink channel. Transmitting an uplink transmission on an uplink resource can be understood as transmitting the uplink transmission by using the uplink resource. Similarly, downlink data/signals/channels/information may be understood accordingly.

In the embodiments of the present disclosure, high layer signaling may be e.g. radio resource control (RRC) signaling; for example, is called an RRC message, for example includes an MIB, system information, and a dedicated RRC message; or is called an RRC information element (RRC IE). The high layer signaling, for example, may further be Medium Access Control (MAC) signaling; or called a MAC control element (MAC CE). In addition, the high layer signaling e.g. may further be a PDCP-controlled PDU, an RLC-controlled PDU, a SRAP-controlled PDU, etc., however the present disclosure is not limited to this.

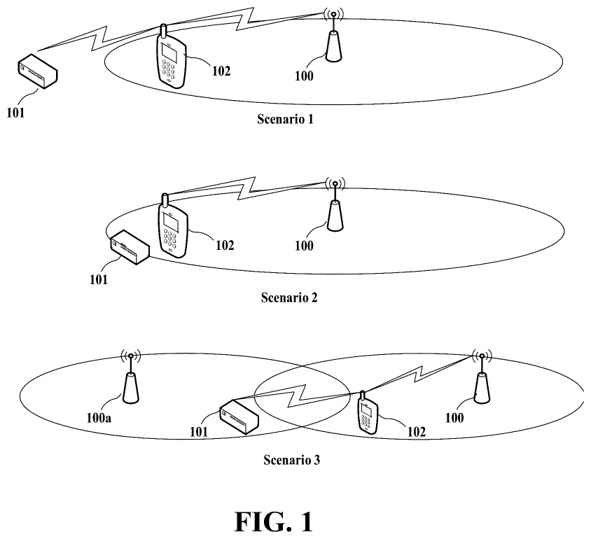

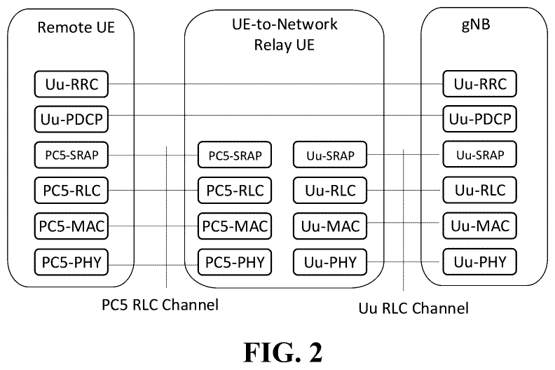

In the embodiments of the present disclosure, the first terminal equipment may be the remote UE 101 as shown in FIG. 1, the target second terminal equipment may be the relay UE 102 as shown in FIG. 1, and the network device may be the network device 100 as shown in FIG. 1.

The target second terminal equipment may be one of a plurality of candidate second terminal equipments, and the candidate second terminal equipment may be one or more in the second terminal equipments. The target second terminal equipment may be called a target relay UE, and the candidate second terminal equipment may be called a candidate relay UE.

The first terminal equipment may communicate directly with a network device, i.e., the communication path is called a direct path. The first terminal equipment may also communicate with the network device via the second terminal equipment, i.e., the communication path is an indirect path. A communication path between the first terminal equipment and the network device may be switched from the direct path to the indirect path (i.e., direct-to-indirect path switch).

### Embodiments of a First Aspect

The embodiments of the first aspect of the present disclosure are used to solve the problem in the above Option 1, that is, during the direct to indirect path switch, how to ensure that a target relay UE is in a connected mode.

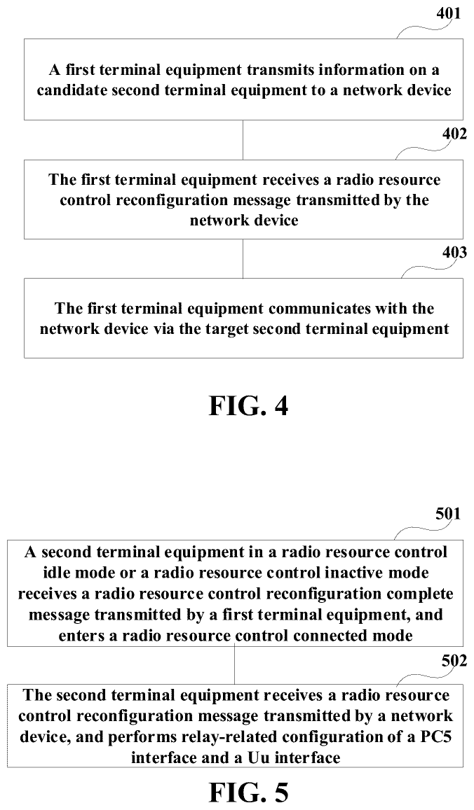

FIG. 4 is a schematic diagram of a method for transceiving information in the embodiments of a first aspect. As shown in FIG. 4, the method for transceiving information includes:

Operation 401, a first terminal equipment transmits information on a candidate second terminal equipment to a network device;

Operation 402, the first terminal equipment receives a radio resource control reconfiguration (RRC reconfiguration) message transmitted by the network device, the radio resource control reconfiguration (RRC reconfiguration) message including information on a target second terminal equipment (relay UE) in a radio resource control connected (RRC_connected) mode; and

Operation 403, the first terminal equipment communicates with the network device via the target second terminal equipment.

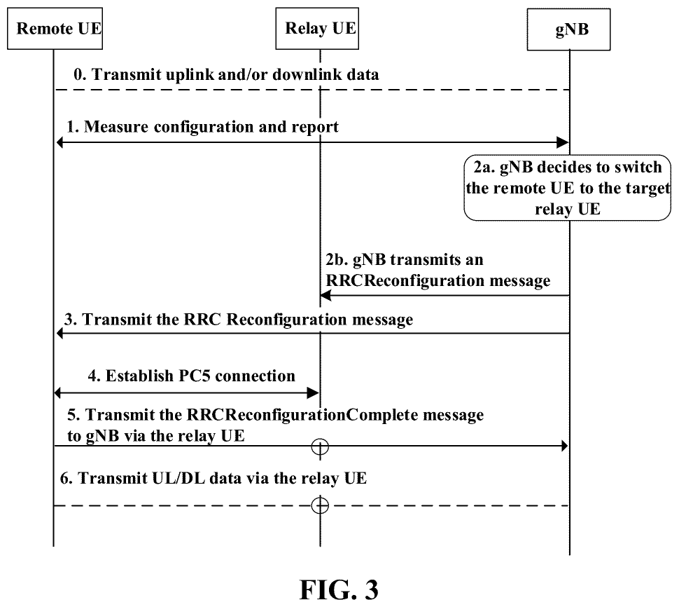

Through the embodiments of the first aspect of the present disclosure, the network device transmits a radio resource control reconfiguration message to the remote UE and the radio resource control reconfiguration message includes information on the target relay UE in radio resource control connected mode, thereby enabling the target relay UE to be in the RRC connected mode, which is conducive to switching a communication path between the remote UE and the network device by using the existing direct-to-indirect path switch flow (such as the flow shown in FIG. 3), resulting in less service interruption time of the remote UE. In addition, its implementation mode of this method is simple and the implementation complexity is low.

Next, the implementations of the method shown in FIG. 4 are specifically described.

### Implementation A1:

In the implementation A1, a target second terminal equipment (such as a target relay UE) in an RRC reconfiguration message transmitted by a network device (such as a gNB) to a first terminal equipment (such as a remote UE) is a relay UE in an RRC connected mode. That is, the network device may select a relay UE in the RRC_connected mode from candidate second terminal equipments (such as candidate relay UEs) reported by the remote UE, as a target relay UE.

For example, in an embodiment, the relay UE reports its own L2 ID to the gNB after entering the RRC_connected mode, or the relay UE reports its own changed L2 ID to the gNB when its own L2 ID is changed, the L2 ID may be an identifier assigned by an upper layer (such as a V2X layer or a ProSe layer or a NAS layer) in the relay UE, for example 24 bits, the L2 ID may be an L2 ID of the relay UE for a relay service. In addition, the relay UE may further report to the gNB its own relay capability (such as L2 UE-to-Network relay-related capability), etc., so that the gNB may obtain which L2 ID relay UEs are in the RRC_connected mode. When the gNB receives the L2 ID of a candidate relay UE in a remote UE measurement report, the gNB selects a relay UE in the RRC_connected mode from the candidate relay UEs as a target relay UE of the remote UE switching path according to the L2 ID of the relay UE reported to the gNB by the relay UE after entering the RRC_connected mode.

For another example, in another embodiment, the gNB assigns a cell radio network temporary identifier (C-RNTI) to the relay UE, thus the gNB knows the C-RNTI of the relay UE in the RRC_connected mode, and the remote UE may also report a C-RNTI of a candidate relay UE in the measurement report, whereby the gNB may select the relay UE in the RRC_connected mode as a target relay UE of the remote UE switching path according to the C-RNTI. In this embodiment, the relay UE needs to inform the remote UE of its own C-RNTI, for example, it may be transmitted via a PC5-S message or a PC5-RRC messages or a sidelink media access control control element (Sidelink MAC CE) or a sidelink control information (SCI), etc. The PC5-S message may be a discovery solicitation message or a discovery response message or a direct communication request message or a direct communication accept message, etc; the PC5-RRC message may be a sidelink notification message (NotificationMessageSidelink) or a sidelink transfer Uu message (UuMessageTransferSidelink), etc.

### Implementation A2:

In the implementation A2, the remote UE may report a candidate relay UE in the RRC connected mode to a network device. The relay UE may indicate an RRC mode of the relay UE to the remote UE, whereby the remote UE may only report the candidate relay UE in the RRC connected mode to the network device, that is, a measurement report transmitted by the remote UE to the network device may include candidate relay UE in the RRC_connected mode, but does not include a candidate relay UE in an RRC_idle mode or an RRC_inactive mode.

In the implementation A2, an indication transmitted by the relay UE to the remote UE may be 1 bit (for example, in the indication of the 1 bit, 1 represents that the relay UE is in the RRC_connected mode, 0 represents that the relay UE is in other mode), or, the indication transmitted by the relay UE to the remote UE may contain the RRC mode of the relay UE (for example, the RRC mode of the relay UE may be RRC_connected or RRC_idle or RRC_inactive).

In the implementation A2, the indication transmitted by the relay UE to the remote UE may be transmitted via an PC5-S message or a PC5-RRC message or sidelink system information or a sidelink media access control control element (Sidelink MAC CE), etc. The PC5-S message may be a discovery solicitation message or a discovery response message or a direct communication request message or a direct communication accept message, etc; the PC5-RRC message may be a sidelink notification message (NotificationMessageSidelink) or a sidelink transfer Uu message (UuMessageTransferSidelink), etc.; the sidelink system information may be a side-link master information block (SL-MIB, MasterInformationBlockSidelink), etc.; the sidelink MAC CE may be a MAC CE having one byte length, etc.

### Implementation A3:

In the implementation A3, a network device may indicate a relay UE in an RRC_connected mode in a measurement configuration, whereby a remote UE may only measure the quality of a link between relay UEs in the RRC_connected mode.

In at least one embodiment of the implementation A3, when configuring a measurement object, for the relay UEs, the network device may add information of the relay UEs, the added information of the relay UEs e.g., is L2 IDs or C-RNTIs of the relay UEs, these relay UEs are in the RRC connected mode. In this way, when receiving a relay measurement object configuration, the remote UE may only measure the relay UEs indicated by the network device, that is, the relay UEs in the RRC_connected mode, thus candidate relay UEs in the measurement report transmitted by the remote UE to the network device are the relay UEs in the RRC_connected mode.

### Implementation A4:

In the implementation A4, a relay UE that provides a relay service is kept in the RRC_connected mode. If the relay UE enters into an RRC_idle or RRC_inactive mode, the relay UE does not provide the relay service.

In the implementation A4, a network device may not indicate the relay UE to enter into the RRC idle or RRC_inactive mode, for example, the network device does not transmit an RRC release message or an RRC release message with a suspend indication to a relay UE that is capable of being acted as a relay or to be acted as a relay, or the network device accepts RRC connection establishment request or RRC reestablishment request or RRC resume request of the relay UE, etc., that is, the network device does not reject these requests of the relay UE, so that the relay UE is kept in the RRC_connected mode; and/or, when the relay UE is in the RRC idle or RRC_inactive mode, the relay UE does not transmit a message related to the discovery procedure to the remote UE, for example, the relay UE does not transmit at least one of the following messages on a sidelink: a discovery solicitation message, a discovery response message, a direct communication request message, a direct communication accept message or sidelink system information (such as SL-MIB), so as to prevent the remote UE from discovering the relay UE, or the relay UE does not perform relay-related functions, for example, in a discovery solicitation message and/or a discovery response message and/or a direct communication request message and/or a direct communication accept message and/or sidelink system information (such as SL-MIB) transmitted by the relay UE on a sidelink, the relay UE indicates itself not to perform relay-related functions or does not have a relaying capability or does not provide connection from the remote UE to a network.

According to the embodiments of the first aspect, a method to keep the target relay UE in the RRC_connected mode is provided, which is conducive to switching a path between the remote UE and the network communication by using the existing direct-to-indirect path switch flow, resulting in less service interruption time of the remote UE. In addition, the method for transceiving a signal in the embodiments of the first aspect is simple, and its implementation complexity is low.

### Embodiments of a Second Aspect

The embodiments of the second aspect of the present disclosure are used to solve the problem in the above Option 2, that is, during the direct to indirect path switch, how does the target relay UE receive an RRC reconfiguration message if the target relay UE is in an RRC_idle or RRC_inactive mode?

FIG. 5 is another schematic diagram of a method for transceiving information in the embodiments of a second aspect. As shown in FIG. 5, the method for transceiving information includes:

Operation 501, a second terminal equipment (relay UE) in a radio resource control idle (RRC_idle) mode or a radio resource control inactive (RRC_inactive) mode receives a radio resource control reconfiguration complete (RRC reconfiguration complete) message transmitted by a first terminal equipment, and enters into a radio resource control connected (RRC_connected) mode; and

Operation 502, the second terminal equipment receives a radio resource control reconfiguration (RRC reconfiguration) message transmitted by a network device, and performs relay-related configuration of a PC5 interface and a Uu interface.

In the operation 502, the RRC reconfiguration message for the relay UE may be transmitted after the relay UE enters into the RRC_connected mode, or may also be transmitted after the relay UE enters into the RRC_connected mode and transmits L2 ID of the relay UE to a network device (such as a gNB).

In the embodiments of the second aspect, the relay UE may transmit the L2 ID of the relay UE to the gNB via e.g. a Sidelink UE Information (SUI) message, the aim is to enable the gNB to identify that the relay UE that enters into the RRC_connected mode is the target relay UE of the remote UE for path switch, so as to subsequently transmit the RRC reconfiguration message to the target relay UE to perform related configuration of a PC5 interface and a Uu interface.

A condition under which the relay UE transmits the L2 ID (for example, L2 ID is transmitted via an SUI message) or a condition under which the SUI procedure is initiated or a purpose of initiating the SUI may include that the relay UE receives the RRC reconfiguration complete message transmitted by the remote UE. For example, The RRC reconfiguration complete message is transmitted by the remote UE to the network device via the relay UE, or the relay UE receives the RRC reconfiguration complete message carried by SRB0 from the remote UE on the PC5 interface, or on the PC5 interface, the relay UE receives an RRC reconfiguration complete message transmitted by the remote UE using a default configuration (or specified configuration or predefined configuration), the default configuration (or specified configuration or predefined configuration) may be a default (or specified or predefined) sidelink RLC bearer configuration, such as a default (or specified or predefined) SL-RLC0 configuration or a default SL-RLC1 configuration, the default (or specified or predefined) sidelink RLC bearer configuration may include at least one of the following: a SN field length, a reassembly time, a logical channel identity, a logical channel priority, a prioritized bit rate, or a logical channel group configuration, etc.

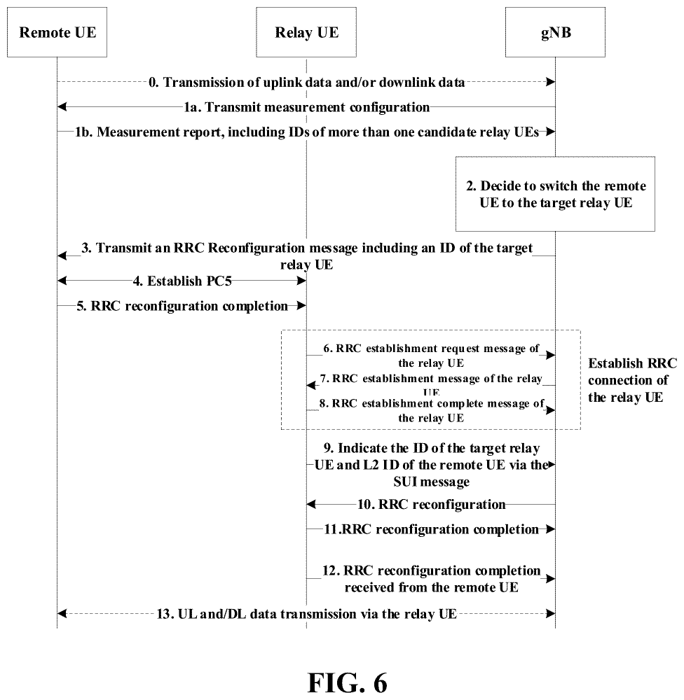

FIG. 6 is a schematic diagram of direct-to-indirect path switch in the case where a relay UE is in an RRC idle or RRC_inactive mode. As shown by FIG. 6, the path switch procedure includes the following operations:

Operation 0. Uplink data and/or downlink data (UL/DL data) are transmitted between the remote UE and the network device (e.g., gNB) via a Uu interface.

Operation 1a. The gNB transmits Measurement configuration to the remote UE.

Operation 1b. The remote UE reports ID(s) of one or more candidate relay UEs after measuring and/or discovering candidate relay UE(s); in addition, the remote UE may further report traditional Uu measurement results.

The remote UE may at least report a relay UE ID, a serving cell ID of the relay UE, and SL measurement information, wherein the SL measurement information may be sidelink-referencesignalreceivedpower (SL-RSRP) of a candidate relay UE, and if the SL-RSRP is not available, sidelink discovery-referencesignalreceivedpower (SD-RSRP) is used.

Operation 2. The gNB decides to switch the remote UE to a target relay UE.

Operation 3. The gNB transmits the RRCReconfiguration message to the remote UE. Content of the message may at least include a Relay UE ID, PC5 RLC configuration of a relay service, and a related end-to-end radio bearer. After receiving the RRCReconfiguration message of the gNB, the remote UE stopped transmission of a user plane (UP) and a control plane (CP).

Operation 4. The remote UE establishes a PC5 connection with the target relay UE.

Operation 5. The remote UE transmits a radio resource control reconfiguration complete (RRCReconfigurationComplete) to the target relay UE.

Operation 6. The target relay UE transmits a radio resource control establishment request message to the gNB. For example, when the target relay UE receives the RRC reconfiguration complete message from the remote UE, the RRC connection establishment procedure for the target relay UE itself is triggered.

Operation 7. The gNB transmits a radio resource control establishment message to the target relay UE.

Operation 8. The target relay UE transmits to the gNB a radio resource control establishment complete message.

Operation 9. The target relay UE indicates a UE identifier (UE ID, such as L2 ID or C-RNTI) of the target relay UE and a layer 2 identifier (L2 ID) of the remote UE via an SUI message.

Operation 10. The gNB transmits a radio resource control reconfiguration (RRC reconfiguration) message to the target relay UE, the message may at least include a local identifier (local ID) and a layer 10 identifier (L2 ID) of the remote UE, RLC configuration of Uu and PC5 interfaces for relaying, and bearer mapping configuration.

Operation 11. The target relay UE transmits to the gNB a radio resource control reconfiguration complete (RRC reconfiguration complete) message.

Operation 12. The target relay UE forwards to the gNB the radio resource control reconfiguration complete (RRC reconfiguration complete) message transmitted by the remote UE and received in the operation 5, to complete the path switch procedure.

Operation 13. A data path between the remote UE and the gNB is switched from a direct path to an indirect path, that is, the remote UE performs uplink data and/or downlink data (UL and/or DL data) transmission with the gNB via the target relay UE.

In the operation 3 of FIG. 6, the remote UE has received the RRC reconfiguration message transmitted by the network device and may perform related configuration such as SRAP and RLC channel of the PC5 interface. Therefore, in the operation 5, the remote UE may theoretically transmit the RRC reconfiguration complete message on SRB1, and the RRC reconfiguration complete message is transmitted on the PC5 interface by using a SRAP sublayer. However, the relay UE has not received the RRC reconfiguration message transmitted by the network device to perform related configuration of the PC5 interface and the Uu interface (including SRAP configuration and RLC channel configuration of the PC5 interface), for example, the relay UE may not have established or configured a SRAP entity and/or RLC channel on the PC5 interface, thus if the remote UE transmits the RRC reconfiguration complete message by using the SRAP sublayer to, the relay UE is not able to receive the RRC reconfiguration complete message correctly.

Therefore, in the operation 5 of FIG. 6, in order to ensure that the target relay UE can correctly receive the RRC reconfiguration complete message transmitted by the remote UE, the RRC reconfiguration complete message of remote UE may be transmitted on the PC5 interface without the use of SRAP related functions or SRAP does not appear, or, the RRC reconfiguration complete message of remote US may be transmitted using SRB0, or the remote UE may transmit the RRC reconfiguration complete messages using a default configuration, the default configuration (or specified configuration or predefined configuration) may be the default (or specified or predefined) sidelink RLC bearer configuration, etc. as described above.

Through the method for transceiving information in the embodiments of the second aspect, in a case where a relay UE originally in the RRC_idle mode or RRC_inactive mode enters into the RRC_connected mode and serves as a target relay UE, a RRC reconfiguration complete message may be received correctly transmitted by the remote UE at the PC5 interface, and it is ensured that the remote UE successfully completes switching from a direct path to the remote UE communicating with a network via the relay UE in the RRC_connected mode.

### Embodiments of a Third Aspect

Embodiments of a third aspect provide an apparatus for transceiving information. The apparatus is applicable to a network device, such as the network device 100 in FIG. 1. The function of the apparatus for transceiving information corresponds to the method for the network device in the embodiments of the first aspect.

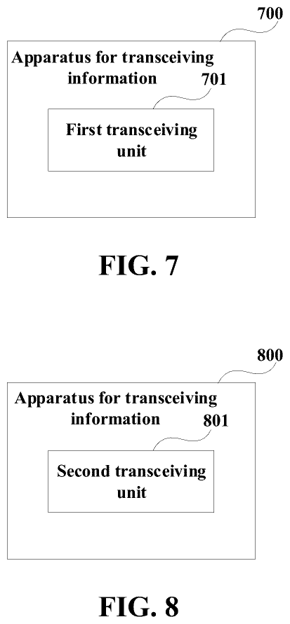

FIG. 7 is a schematic diagram of an apparatus for transceiving information described in the embodiments of a third aspect. As shown in FIG. 7, an apparatus 700 for transceiving information includes a first transceiving unit 701 configured to:
receive information on a candidate second terminal equipment (relay UE) transmitted by a first terminal equipment (such as remote UE);
transmit a radio resource control reconfiguration message to the first terminal equipment, the radio resource control reconfiguration (RRC reconfiguration) message including information on a target second terminal equipment (such as target relay UE) in a radio resource control connected (RRC_connected) mode; and
communicate with the first terminal equipment via the target second terminal equipment.

Through the embodiments of the third aspect, the target second terminal equipment is enabled to be in the RRC_connected mode, which is conducive to switching a path between the remote UE and the network communication by using the existing direct-to-indirect path switch flow, resulting in less service interruption time of the remote UE. In addition, implementation of the method is simple, and its implementation complexity is low.

Corresponding to the implementation A1 in the embodiments of the first aspect, the first transceiving unit 701 may select a candidate second terminal equipment in a radio resource control connected (RRC_connected) mode as a target second terminal equipment according to the information on the candidate second terminal equipment (such as candidate relay UE) transmitted by the first terminal equipment.

In an embodiment, the first transceiving unit 701 receives identification information transmitted by the second terminal equipment entering the radio resource control connected (RRC_connected) mode, for example the identification information is a layer 2 identifier (L2 ID). The first transceiving unit 701 selects a candidate second terminal equipment in a radio resource control connected (RRC_connected) mode based on the identification information and the information on the candidate second terminal equipment (such as candidate relay UE) transmitted by the first terminal equipment.

For example, the candidate second terminal equipment (such as candidate relay UE) reports its own L2 ID to the gNB after entering the RRC_connected mode, or the candidate relay UE reports its own changed L2 ID to the gNB when its own L2 ID is changed, the L2 ID may be an identifier assigned by an upper layer (such as a V2X layer or a ProSe layer or a NAS layer) in the candidate relay UE, for example 24 bits, the L2 ID may be L2 ID of the candidate relay UE for a relay service. In addition, the candidate relay UE may further report its own relay capability (such as L2 UE-to-Network relay-related capability), etc. to the gNB (such as the first transceiving unit 701 of the gNB), so that the gNB can obtain which L2 ID relay UEs are in the RRC_connected mode. When the gNB receives the L2 ID of a candidate relay UE in a remote UE measurement report, the gNB selects a relay UE in the RRC_connected mode from the candidate relay UEs as a target relay UE of the remote UE switching path, according to the L2 ID of the relay UE reported to the gNB by the relay UE after entering the RRC_connected mode.

In another embodiment, a network device may assign identification information of the second terminal equipment, for example, the identification information is a cell radio network temporary identifier (C-RNTI). The first transceiving unit 701 may select a candidate second terminal equipment in a radio resource control connected (RRC_connected) mode based on the identification information and the information on the candidate second terminal equipment (such as candidate relay UE) transmitted by the first terminal equipment.

In a case where the identification information is a cell radio network temporary identifier (C-RNTI), the second terminal equipment may transmit the identification information of the second terminal equipment to the first terminal equipment.

Corresponding to the implementation A2 in the embodiments of the first aspect, the first transceiving unit 701 may receive information on a candidate second terminal equipment (relay UE) in a radio resource control connected (RRC_connected) mode, transmitted by the first terminal equipment.

Corresponding to the implementation A3 in the embodiments of the first aspect, the first transceiving unit 701 may further be configured to: transmit to the first terminal equipment indication information indicating the second terminal equipment in a connected mode. Hence, the first terminal equipment may measure the second terminal equipment in the connected mode based on the indication information, and the first transceiving unit 701 may receive information on the candidate second terminal equipment (relay UE) in the connected mode, transmitted by the first terminal equipment based on a measurement result.

Corresponding to the implementation A4 in the embodiments of the first aspect, for the target second terminal equipment in the radio resource control connected (RRC_connected) mode, the first transceiving unit 701 does not indicate that the target second terminal equipment enters a non-connected mode. For example, the first transceiving unit 701 will not transmit an RRC release message or an RRC release message with a Suspend indication to a relay UE capable of being acted as a relay or to be acted as a relay, or the first transceiving unit 701 accepts the relay UE's RRC connection establishment request or RRC reestablishment request or RRC Resume request, etc., i.e., the first transceiving unit 701 does not reject these requests from the relay UE to keep the relay UE in the RRC_connected mode.

### Embodiments of a Fourth Aspect

Embodiments of a fourth aspect provide an apparatus for transceiving information. The apparatus is applicable to a first terminal equipment, such as the remote UE 101 in FIG. 1. The function of the apparatus for transceiving information corresponds to the method for the remote UE in the embodiments of the first aspect.

FIG. 8 is a schematic diagram of an apparatus for transceiving information described in the embodiments of a fourth aspect. As shown in FIG. 8, an apparatus 800 for transceiving information includes a second transceiving unit 801 configured to:
transmit information on a candidate second terminal equipment (such as a candidate relay UE) to a network device;
receive a radio resource control reconfiguration (RRC reconfiguration) message transmitted by the network device, the radio resource control reconfiguration (RRC reconfiguration) message including information on a target second terminal equipment (relay UE) in a radio resource control connected (RRC_connected) mode; and
communicate with the network device via the target second terminal equipment.

Through the embodiments of the fourth aspect, the target second terminal equipment is enabled to be in the RRC_connected mode, which is conducive to switching a path between the remote UE and the network communication by using the existing direct-to-indirect path switch flow, resulting in less service interruption time of the remote UE. In addition, implementation of the method is simple, and its implementation complexity is low.

Corresponding to the implementation A2 in the embodiments of the first aspect, the second transceiving unit 801 transmits to a network device information on the candidate second terminal equipment (such as candidate relay UE) in a radio resource control connected (RRC_connected) mode.

The second transceiving unit 801 is further configured to: receive indication information indicating an RRC mode of the second terminal equipment, transmitted by the second terminal equipment. Hence, the second transceiving unit 801 may transmit to the network device the information on the candidate second terminal equipment (relay UE) in the radio resource control connected (RRC_connected) mode based on the indication information. For example, the indication transmitted by the relay UE to the second transceiving unit 801 may be transmitted via an PC5-S message or a PC5-RRC message or sidelink system information or a sidelink media access control control element (Sidelink MAC CE), etc. The PC5-S message may be a discovery solicitation message or a discovery response message or a direct communication request message or a direct communication accept message, etc; the PC5-RRC message may be a sidelink notification message (NotificationMessageSidelink) or a sidelink transfer Uu message (UuMessageTransferSidelink), etc.; the sidelink system information may be a side-link master information block (SL-MIB, MasterInformationBlockSidelink), etc.; the sidelink MAC CE may be a MAC CE having one byte length, etc.

Corresponding to the implementation A3 in the embodiments of the first aspect, the second transceiving unit 801 may further be configured to:
receive the indication information, transmitted by the network device, indicating the second terminal equipment in the connected mode; and
measure the second terminal equipment in the connected mode based on the indication information.

Accordingly, the second transceiving unit 801 may transmit the information on the candidate second terminal equipment (such as candidate relay UE) in the connected mode based on a result of the measurement.

### Embodiments of a Fifth Aspect

Embodiments of a fifth aspect provide an apparatus for transceiving information. The apparatus is applicable to a second terminal equipment, such as the relay UE 102 in FIG. 1. The function of the apparatus for transceiving information corresponds to the method for the relay UE in the implementation A4 in the embodiments of the first aspect.

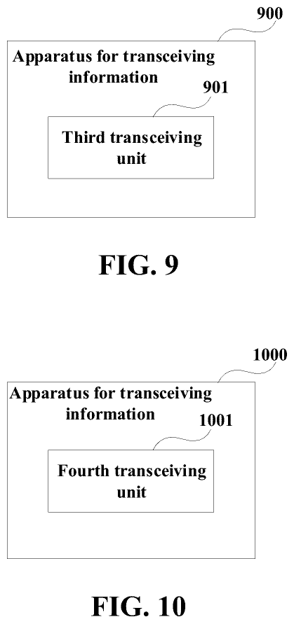

FIG. 9 is a schematic diagram of an apparatus for transceiving information described in the embodiments of a fifth aspect. As shown in FIG. 9, an apparatus 900 for transceiving information includes a third transceiving unit 901 configured to:
in a case where the second terminal equipment is not in a radio resource control connected (RRC_connected) mode (for example, in an RRC_idle or RRC_inactive mode), not transmit a message related to a discovery procedure or not perform a relaying-related function.

The third transceiving unit 901 does not transmit a message related to a discovery procedure or does not perform a relaying-related function, for example including: the third transceiving unit 901 does not transmit at least one of the following messages on a sidelink: a discovery solicitation message, a discovery response message, a direct communication request message, a direct communication accept message, and sidelink system information (such as SL-MIB), to prevent the remote UE from discovering the relay UE. The third transceiving unit 901 does not perform a relaying-related function, for example including: in a discovery solicitation message and/or a discovery response message and/or a direct communication request message and/or a direct communication accept message and/or sidelink system information (such as SL-MIB) transmitted on a sidelink, the third transceiving unit 901 indicates itself not to perform a relaying-related function or does not have a relaying capacity or does not provide connection from a remote UE to a network, etc.

Accordingly, a situation in which a relay UE that is not in the radio resource control connected (RRC_connected) mode is not discovered by the remote UE may be avoided, or a situation in which the relay UE provides a relaying service to the remote UE is avoided.

### Embodiments of a Sixth Aspect

Embodiments of a sixth aspect provide an apparatus for transceiving information. The apparatus is applicable to a network device, such as the network device 100 in FIG. 1. The function of the apparatus for transceiving information corresponds to the method for the network device in the embodiments of the second aspect.

FIG. 10 is a schematic diagram of an apparatus for transceiving information described in the embodiments of a sixth aspect. As shown in FIG. 10, an apparatus 1000 for transceiving information includes a fourth transceiving unit 1001 configured to:
in a case where the second terminal equipment enters the radio resource control connected (RRC_connected) mode, transmit a radio resource control reconfiguration (RRC reconfiguration) message to the second terminal equipment, so that the second terminal equipment performs relay-related configuration of a PC5 interface and a Uu interface.

In at least one embodiment, the fourth transceiving unit 1001 is further configured to: receive identification information transmitted by the second terminal equipment. For example, the fourth transceiving unit 1001 receives the identification information from the second terminal equipment via a Sidelink UE Information (SUI) message. The identification information e.g. may be L2 ID of the second terminal equipment.

In at least one embodiment, before transmitting the radio resource control reconfiguration (RRC reconfiguration) message (such as the operation 10 in FIG. 6), the fourth transceiving unit 10 receives the identification information (such as the operation 9 in FIG. 6) from the second terminal equipment via a Sidelink UE Information (SUI) message.

Through the embodiments of the sixth aspect, in a case where a relay UE originally in the RRC_idle mode or RRC_inactive mode enters into the RRC_connected mode and serves as a target relay UE, a RRC reconfiguration complete message may be received correctly transmitted by the remote UE at the PC5 interface, and it is ensured that the remote UE successfully completes switching from a direct path to the remote UE communicating with a network via the relay UE in the RRC_connected mode.

### Embodiments of a Seventh Aspect

Embodiments of a seventh aspect provide an apparatus for transceiving information. The apparatus is applicable to a second terminal equipment, such as the relay UE 102 in FIG. 1. The function of the apparatus for transceiving information corresponds to the method for the second terminal equipment (such as the relay UE) in the embodiments of the second aspect.

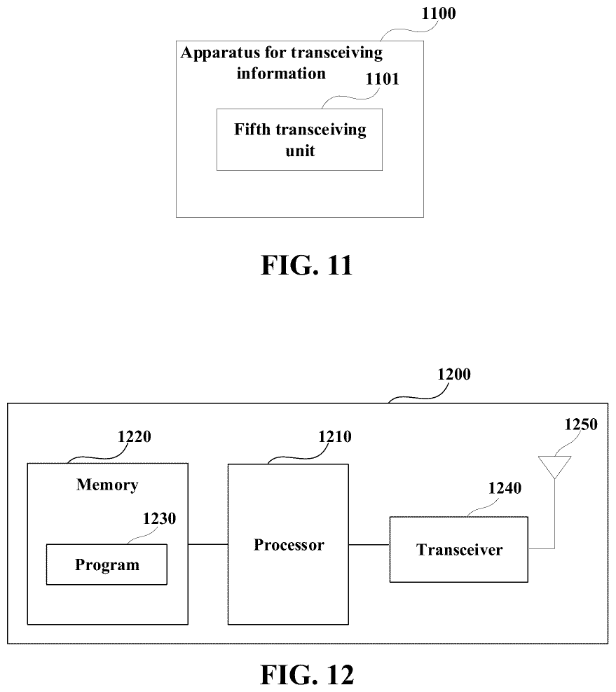

FIG. 11 is a schematic diagram of an apparatus for transceiving information described in the embodiments of a seventh aspect. As shown in FIG. 11, an apparatus 1100 for transceiving information includes a fifth transceiving unit 1101 configured to:
receive a radio resource control reconfiguration complete (RRC reconfiguration complete) message transmitted by a first terminal equipment (remote UE) when the second terminal equipment is in a radio resource control idle (RRC_idle) mode or a radio resource control inactive (RRC_inactive) mode, and enable the second terminal equipment to enter a radio resource control connected (RRC_connected) mode; and
receive a radio resource control reconfiguration (RRC reconfiguration) message transmitted by a network device, and enable the second terminal equipment to perform relay-related configuration of a PC5 interface and a Uu interface.

In at least one embodiment, the fifth transceiving unit 1101 is further configured to: transmit identification information to a network device. The identification information e.g. is an L2 ID of the second terminal equipment.

The fifth transceiving unit 1101 may transmit the identification information to the network device via a Sidelink UE Information (SUI) message.

A condition for the fifth transceiving unit 1101 to transmit the identification information or a condition for initiating an SUI procedure or a purpose for initiating an SUI may include: the second terminal equipment receives a radio resource control reconfiguration complete (RRC reconfiguration complete) message transmitted by the first terminal equipment. For example, the RRC reconfiguration complete message is transmitted by the first terminal equipment (such as remote UE) to a network device via the second terminal equipment (such as relay UE), or SRB0 received by the fifth transceiving unit 1101 from the first terminal equipment at the PC5 interface bears the radio resource control reconfiguration complete (RRC reconfiguration complete) message, or the fifth transceiving unit 1101 may receive at the PC5 interface the radio resource control reconfiguration complete (RRC reconfiguration complete) message from the first terminal equipment by using a default configuration, the default configuration (or specified configuration or predefined configuration) may be a default (or specified or predefined) sidelink RLC bearer configuration, such as a default (or specified or predefined) SL-RLC0 configuration or a default (or specified or predefined) SL-RLC1 configuration, the default (or specified or predefined) sidelink RLC bearer configuration may include at least one of the following: a SN field length, a reassembly time, a logical channel identity, a logical channel priority, a prioritized bit rate, or a logical channel group configuration, etc.

In at least one embodiment, after transmitting the identification information to the network device, the fifth transceiving unit 1101 receives a radio resource control reconfiguration (RRC reconfiguration) message from the network device.

Through the embodiments of the seventh aspect, in a case where a relay UE originally in the RRC_idle mode or RRC_inactive mode enters into the RRC_connected mode and serves as a target relay UE, a RRC reconfiguration complete message may be received correctly transmitted by the remote UE at the PC5 interface, and it is ensured that the remote UE successfully completes switching from a direct path to the remote UE communicating with the network via the relay UE in the RRC_connected mode.

### Embodiments of an Eighth Aspect

The embodiments of the present disclosure further provide a communication system which may include a first terminal equipment, a second terminal equipment and a network device, for example the first terminal equipment may be the remote UE 101 in FIG. 1, the second terminal equipment may be the relay UE 102 in FIG. 1, and the network device may be network device 100 in FIG. 1. The first terminal equipment and the second terminal equipment may adopt a similar terminal equipment structure.

FIG. 12 is a schematic diagram of a terminal equipment in a communication system in the embodiments of an eighth aspect. The terminal equipment as shown in FIG. 12 may be used for the first terminal equipment, or may also be used for the second terminal equipment.

As shown in FIG. 12, a terminal equipment 1200 may include: a processor 1210 (such as a central processing unit (CPU)) and a memory 1220; the memory 1220 is coupled to the processor 1210. The memory 1220 may store various data; moreover, also stores a program 1230 for information processing, and executes the program 1230 under the control of the processor 1210.

For example, the processor 1210 may be configured to execute a program to implement the method described in the embodiments of the first aspect or the second aspect.

In addition, as shown in FIG. 12, the terminal equipment 1200 may further include: a transceiver 1240 and an antenna 1250, etc., wherein the functions of said components are similar to relevant arts, which are not repeated here. It is worth noting that the terminal equipment 1200 does not have to include all the components shown in FIG. 12. Moreover, the terminal equipment 1200 may also include components not shown in FIG. 12, relevant art may be referred to.

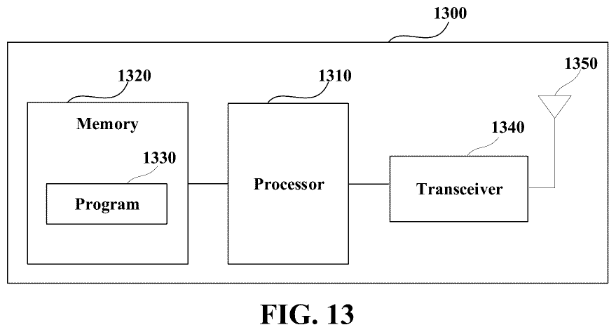

FIG. 13 is a schematic diagram of a network device in a communication system in the embodiments of an eighth aspect.

As shown in FIG. 13, a network device 1300 may include: a processor 1310 (such as a central processing unit (CPU)) and a memory 1320; the memory 1320 is coupled to the processor 1310. The memory 1320 may store various data; moreover, also stores a program 1330 for information processing, and executes the program 1330 under the control of the processor 1310.

For example, the processor 1310 may be configured to execute a program to implement the method described in the embodiments of the first aspect or the second aspect.

In addition, as shown in FIG. 13, the network device 1300 may further include: a transceiver 1340 and an antenna 1350, etc., wherein the functions of said components are similar to relevant arts, which are not repeated here. It's worth noting that the network device 1300 does not have to include all the components shown in FIG. 13. Moreover, the network device 1300 may also include components not shown in FIG. 13, relevant art may be referred to.

The embodiments of the present disclosure further provide a computer program, wherein when the program is executed in a first terminal equipment or a second terminal equipment, the program enables the first terminal equipment or the second terminal equipment to execute the method described in the embodiments of the first and second aspects.

The embodiments of the present disclosure further provide a storage medium in which a computer program is stored, wherein the computer program enables the first terminal equipment or the second terminal equipment to execute the method described in the embodiments of the first and second aspects.

The embodiments of the present disclosure further provide a computer program, wherein when a network device executes the program, the program enables the network device to execute the method described in the embodiments of the first and second aspects.

The embodiments of the present disclosure further provide a storage medium in which a computer program is stored, wherein the computer program enables a network device to execute the method described in the embodiments of the first and second aspects.

The apparatus and method in the present disclosure can be realized by hardware, or can be realized by combining hardware with software. The present disclosure relates to such a computer readable program, when the program is executed by a logic component, the computer readable program enables the logic component to realize the apparatus described in the above text or a constituent component, or enables the logic component to realize various methods or steps described in the above text. The present disclosure also relates to a storage medium storing the program, such as a hard disk, a magnetic disk, an optical disk, a DVD, a flash memory and the like.

By combining with the method/apparatus described in the embodiments of the present disclosure, it can be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules can be realized by solidifying these software modules e.g. using a field-programmable gate array (FPGA).

A software module can be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module can be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module can be stored in the MEGA-SIM card or the flash memory apparatus with a large capacity.

One or more in the functional block diagram or one or more combinations in the functional block diagram as described in the drawings can be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings can be also implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art can make various variations and modifications to the present disclosure based on the spirit and principle of the present disclosure, these variations and modifications are also within the scope of the present disclosure.

As for the implementations including the above embodiments, the following supplements are further disclosed:

1. A method for transceiving information, applicable to a network device, the method including:
receiving information on a candidate second terminal equipment transmitted by a first terminal equipment (relay UE);
transmitting a radio resource control reconfiguration message to the first terminal equipment, the radio resource control reconfiguration (RRC reconfiguration) message including information on a target second terminal equipment (relay UE) in a radio resource control connected (RRC_connected) mode; and
communicating, by the network device, with the first terminal equipment via the target second terminal equipment.

2. The method according to Supplement 1, wherein,
the network device selects a candidate second terminal equipment in a radio resource control connected (RRC_connected) mode as the target second terminal equipment according to the information on the candidate second terminal equipment (relay UE) transmitted by the first terminal equipment.

3. The method according to Supplement 1 or 2, wherein,
the network device receives identification information transmitted by the second terminal equipment entering the radio resource control connected (RRC_connected) mode,
the network device selects a candidate second terminal equipment in a radio resource control connected (RRC_connected) mode based on the identification information and the information on the candidate second terminal equipment (relay UE) transmitted by the first terminal equipment.

4. The method according to Supplement 3, wherein,
the identification information is layer 2 (L2) identification information.

5. The method according to Supplement 1 or 2, wherein,
the network device allocates the identification information of the second terminal equipment,
and the network device selects a candidate second terminal equipment in a radio resource control connected (RRC_connected) mode based on the identification and the information on the candidate second terminal equipment (relay UE) transmitted by the first terminal equipment.

6. The method according to Supplement 5, wherein,
the identification information is a cell radio network temporary identifier (C-RNTI).

7. The method according to Supplement 6, wherein,
when the identification information is the cell radio network temporary identifier (C-RNTI), the first terminal equipment receives the identification information transmitted by the second terminal equipment.

8. The method according to Supplement 1, wherein,
the network device receives information on a candidate second terminal equipment (relay UE) in a radio resource control connected (RRC_connected) mode, transmitted by the first terminal equipment.

7. The method according to Supplement 1, wherein,
the method further includes:
the network device transmits indication information indicating the second terminal equipment in a connected mode to the first terminal equipment,
wherein the first terminal equipment measures the second terminal equipment in the connected mode based on the indication information, and
the network device receives the information on the candidate second terminal equipment (relay UE) transmitted by the first terminal equipment based on a result of the measurement.

9. The method according to Supplement 1, wherein,
for the target second terminal equipment in the radio resource control connected (RRC_connected) mode, the network device does not indicate that the target second terminal equipment enters a non-connected mode.

10. A method for transceiving information, applicable to a second terminal equipment, the method including:
in a case of being not in a radio resource control connected (RRC_connected) mode, the second terminal equipment does not transmit a message related to a discovery procedure or does not perform a relay-related function.

11. A method for transceiving information, applicable to a first terminal equipment (a remote UE), the method including:
transmitting information on a candidate second terminal equipment (relay UE) to a network device;
receiving a radio resource control reconfiguration (RRC reconfiguration) message transmitted by the network device, the radio resource control reconfiguration (RRC reconfiguration) message including information on a target second terminal equipment (relay UE) in a radio resource control connected (RRC_connected) mode; and
the first terminal equipment communicating with the network device via the target second terminal equipment.

12. The method according to Supplement 11, wherein,
the first terminal equipment transmits information on a candidate second terminal equipment (relay UE) in a radio resource control connected (RRC_connected) mode to the network device.

13. The method according to Supplement 12, wherein,
the method further includes:
receiving, by the first terminal equipment, indication information indicating an RRC mode of the second terminal equipment, transmitted by the second terminal equipment,
and the first terminal equipment transmit to the network device s information on a candidate second terminal equipment (relay UE) in a radio resource control connected (RRC_connected) mode based on the indication information.

14. The method according to Supplement 11, wherein,
the method further includes:
receiving, by the first terminal equipment, the indication information indicating the second terminal equipment in the connected mode, transmitted by the network device; and
measuring, by the first terminal equipment, the second terminal equipment in the connected mode based on the indication information,
and the first terminal equipment transmits the information on the candidate second terminal equipment (relay UE) to the network device based on a measurement result.

15. A method for transceiving information, applicable to a network device, the method including:
in a case where the second terminal equipment enters the radio resource control connected (RRC_connected) mode,
transmitting a radio resource control reconfiguration (RRC reconfiguration) message to the second terminal equipment, and enabling the second terminal equipment to perform relay-related configuration of a PC5 interface and a Uu interface.

16. The method according to Supplement 15, wherein the method further includes:
receiving identification information transmitted by the second terminal equipment.

17. The method according to Supplement 16, wherein,
the network device receives the identification information from the second terminal equipment via a Sidelink UE Information (SUI) message.

18. The method according to Supplement 16, wherein,
before transmitting radio resource control reconfiguration (RRC reconfiguration) message, the network device receives the identification information from the second terminal equipment via a Sidelink UE Information (SUI) message.

19. A method for transceiving information, applicable to a second terminal equipment (a relay UE), the method including:
receiving, by a second terminal equipment in a radio resource control idle (RRC_idle) mode or a radio resource control inactive (RRC_inactive) mode, a radio resource control reconfiguration complete (RRC reconfiguration complete) message transmitted by a first terminal equipment, and entering a radio resource control connected (RRC_connected) mode; and
receiving a radio resource control reconfiguration (RRC reconfiguration) message transmitted by the network device, and performing relay-related configuration of a PC5 interface and a Uu interface.

20. The method according to Supplement 19, wherein the method further includes:
transmitting, by the second terminal equipment, identification information to the network device.

21. The method according to Supplement 20, wherein,
after transmitting the identification information to the network device, the second terminal equipment receives the radio resource control reconfiguration (RRC reconfiguration) message.

22. The method according to Supplement 20, wherein,
the second terminal equipment transmits the identification information to the network device via a Sidelink UE Information (SUI) message.

23. The method according to Supplement 20, wherein,
a condition for the second terminal equipment to transmit the identification information includes receiving the radio resource control reconfiguration complete (RRC reconfiguration complete) message transmitted by the first terminal equipment.

24. The method according to Supplement 23, wherein,
the radio resource control reconfiguration complete message is transmitted by the first terminal equipment to the network device via the second terminal equipment; or
SRB0 received by the second terminal equipment from the first terminal equipment at the PC5 interface carries the radio resource control reconfiguration complete (RRC reconfiguration complete) message; or
the second terminal equipment receives the radio resource control reconfiguration complete (RRC reconfiguration complete) message transmitted by using default configuration from the first terminal equipment at the PC5 interface.

What is claimed is:

1. An apparatus for transceiving information, applicable to a second terminal equipment, the apparatus comprising:
a receiver configured to:
receive a radio resource control reconfiguration complete message form a first terminal equipment when the second terminal equipment is in a radio resource control idle mode or a radio resource control inactive mode, and cause the second terminal equipment to enter a radio resource control connected mode; and
receive a radio resource control reconfiguration message from a network device; and
processor circuitry configured to perform relay-related configuration of a PC5 interface and a Uu interface according to the radio resource control reconfiguration message.

2. The apparatus according to claim 1, further comprising:
a transmitter configured to transmit identification information to the network device.

3. The apparatus according to claim 2, wherein,
after transmitting the identification information to the network device, the receiver receives the radio resource control reconfiguration message.

4. The apparatus according to claim 2, wherein,
the transmitter transmits the identification information to the network device via a sidelink terminal equipment information message.

5. The apparatus according to claim 2, wherein,
a condition for the transmitter to transmit the identification information includes that the second terminal equipment receives the radio resource control reconfiguration complete message transmitted by the first terminal equipment.

6. The apparatus according to claim 1, wherein,
the radio resource control reconfiguration complete message is transmitted by the first terminal equipment to the network device via the second terminal equipment.

7. The apparatus according to claim 1, wherein,
the receiver is further configured to receive SRB0 carrying the radio resource control reconfiguration complete message from the first terminal equipment at the PC5 interface.

8. The apparatus according to claim 1, wherein,
the receiver is further configured to receive the radio resource control reconfiguration complete message transmitted by using default configuration from the first terminal equipment at the PC5 interface.

9. The apparatus according to claim 1, wherein,
the receiver is further configured to receive the radio resource control reconfiguration message from the network device after entering the radio resource control connected mode.

10. An apparatus, applicable to a first terminal equipment, the apparatus comprising:
a transmitter configured to transmit a radio resource control reconfiguration complete message to a second terminal equipment which is in a radio resource control idle mode or a radio resource control inactive mode, and
processor circuitry configured to:
cause the second terminal equipment to enter a radio resource control connected mode by transmitting the radio resource control reconfiguration complete message.

11. The apparatus according to claim 10,
the processor circuitry is further configured to cause the second terminal equipment to transmit identification information to the network device receive, to receive a radio resource control reconfiguration message from a network device after transmitting the identification information, and to perform relay-related configuration of a PC5 interface and a Uu interface according to the radio resource control reconfiguration message.

12. An apparatus, applicable to a network equipment, the apparatus comprising:
a transmitter configured to transmit a radio resource control reconfiguration message to a second terminal equipment which receives a radio resource control reconfiguration complete message form a first terminal equipment when the second terminal equipment is in a radio resource control idle mode or a radio resource control inactive mode, and control to enter a radio resource control connected mode,
processor circuitry configured to cause second terminal equipment to perform relay-related configuration of a PC5 interface and a Uu interface by transmitting the radio resource control reconfiguration message.

13. The apparatus according to claim 12, further comprising:
a receiver configured to receive identification information to the network device.

14. The apparatus according to claim 13, wherein,
after receiving the identification information, the transmitter transmits the radio resource control reconfiguration message.

15. The apparatus according to claim 13, wherein,
the receiver receives the identification information via a sidelink terminal equipment information message.
